(19) United States
(12) Patent Application Publication
(10) Pub. No.: US 2006/0171148 A1
(43) Pub. Date: Aug. 3, 2006

(54) LED signboard mounting structure

(75) Inventor: Chiao-Sheng Huang, Taipei (TW)

Correspondence Address: BIRCH STEWART KOLASCH & BIRCH, PO BOX 747, FALLS CHURCH, VA, 22040-0747, US

(73) Assignee: AGON-TECH. CORPORATION

(21) Appl. No.: 11/300,324

(22) Filed: Dec. 15, 2005

(30) Foreign Application Priority Data
Jan. 28, 2005 (TW) 094201656

(51) Int. Cl. F21V 21/00

(52) U.S. Cl. 362/249; 362/240; 362/396

(57) ABSTRACT

A light-emitting-diode (LED) signboard mounting structure used to mount at least one LED module on a fixed surface includes at least one mounting support, and at least one interconnecting element. The mounting support is formed at a front side with at least one groove, which transversely extends a full length of the mounting support, has a depth smaller than that of the mounting support and a rear side formed into a retaining channel, and may be alternatively provided at a front side with at least one expanded hole communicating with the retaining channel. The retaining channel has upper and lower ends projected from upper and lower sides of the groove. The interconnecting element is extended into the groove via the expanded hole to hook to the retaining channel on the mounting support.

### FIELD OF THE INVENTION

The present invention relates to an LED (light-emitting-diode) signboard mounting structure, and more particularly to a mounting structure for connecting an LED signboard to a fixed surface.

### BACKGROUND OF THE INVENTION

The mass media play an important role in the nowadays information era. The announcement and promotion of governmental policies, the advertising of business images and products, the live telecast of stage performance, and the display of various information and messages in public places, all can be efficiently and effectively achieved through changeful mass media.

Among others, the LED signboard is a very effective means to achieve ideal advertising effect. Through control via computers and link to Internet, the effect of the LED signboard is expanded from local points to worldwide areas. Moreover, the current mass media display not only static graphic designs, but also dynamic images, making the LED signboard more changeful and flexible to create much enhanced visual effects than other types of advertising media. Since LED's have the advantages of being highly bright, light gathering, and waterproof, having long usable life and low power consumption, and producing less heat, they are very suitable for use on outdoor displays, such as LED signboards.

An LED signboard, no matter what size it has, is always assembled from a plurality of LED modules according to actual needs, and each of the LED modules consists of a plurality of LED's. The LED signboard is provided with control circuits to show different visual effects.

FIGS. 1 and 2 are exploded and assembled perspective views, respectively, showing a conventional manner of mounting an LED signboard. As shown, the LED signboard includes a plurality of LED modules 10, each of which has a case 11. A plurality of LED elements 111 are provided inside the case 11, such that they are visible from an outer side of the case 11. The case 11 is externally provided at four back corners with a receiving area 112 each, to which a mounting element 13 is connected via a fastening element 12. The mounting element 13 has a first end connected to fixed surface 14, and a second end formed into a bent head 131 having a through hole 132 provided thereon.

To mount each of the LED modules 10 on the fixed surface 14, first align the receiving areas 112 at the four back corners of the case 11 with the through holes 132 on the bent heads 131 at the second ends of the mounting elements 13, which have been connected at the first ends to the fixed surface 14, and then extend the fastening elements 12 through the through holes 132 from a rear side of the bent heads 132 into the receiving areas 112 on the case 11. When all the LED modules 10 have been connected to the mounting elements 13, a big-sized LED signboard is formed on the fixed surface 14. The mounting elements 13 are located between the back side of the LED modules 10 and the fixed surface 14, and the LED elements 111 in the cases 11 of the LED modules 10 can be externally viewed from a front side of the cases 11.

To repair any damaged LED modules 10 mounted in the above-described manner, a worker or a maintenance person has to locate between the LED modules 10 and the fixed surface 14 to loosen the fastening elements 12 before the LED modules 10 can be dismounted from the mounting elements 13. It is very inconvenient and dangerous to do so, and it normally requires at least two persons to complete the dismounting and remounting of the LED modules 10.

It is thereby tried by the inventor to develop an LED signboard mounting structure to facilitate convenient and safe mounting and dismounting of the LED signboard to and from a fixed surface.

### SUMMARY OF THE INVENTION

A primary object of the present invention is to provide a mounting structure that allows mounting of an LED signboard on a fixed surface from a front side of the LED signboard.

Another object of the present invention is to provide an LED signboard mounting structure that is simple in structure and easy to install without causing dangers to a mounting or maintenance operator.

To achieve the above and other objects, the LED signboard mounting structure according to the present invention includes at least one mounting support, and at least one interconnecting element. The mounting support is formed at a front side with at least one groove, which transversely extends a full length of the mounting support, has a depth smaller than that of the mounting support and a rear side formed into a retaining channel, and may be alternatively provided at a front side with at least one expanded hole communicating with the retaining channel. The retaining channel has upper and lower ends projected from upper and lower sides of the groove. The interconnecting element is extended into the groove via the expanded hole to hook to the retaining channel on the mounting support.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view showing a conventional LED signboard mounting structure;

FIG. 2 is an assembled view of FIG. 1;

FIG. 3 is an exploded front perspective view showing an LED signboard mounting structure according to a first preferred embodiment of the present invention;

FIG. 4 is an exploded rear perspective view of the LED signboard mounting structure of FIG. 3;

FIG. 5 is an assembled view of FIG. 3;

FIG. 6 is a front view of a mounting support included in the LED signboard mounting structure of FIG. 3;

FIG. 7 is a side view of FIG. 6;

FIG. 8 shows the manner of connecting an LED signboard to the mounting supports according to the first preferred embodiment of the present invention;

FIG. 9 shows a big-sized LED signboard consisting of a plurality of LED modules mounted on a fixed surface using the mounting structure of the present invention;

FIG. 10 is an exploded rear perspective view showing an LED signboard mounting structure according to a second preferred embodiment of the present invention;

FIG. 11 is a side view of FIG. 10;

FIG. 12 shows the manner of mounting an LED signboard to a fixed surface using the mounting structure according to the second preferred embodiment of the present invention;

FIG. 13 is an exploded rear perspective view showing an LED signboard mounting structure according to a third preferred embodiment of the present invention;

FIG. 14 is a side view of FIG. 13;

FIG. 15 shows the manner of mounting an LED signboard to a fixed surface using the mounting structure according to the third preferred embodiment of the present invention;

FIG. 16 is an exploded rear perspective view showing an LED signboard mounting structure according to a fourth preferred embodiment of the present invention;

FIG. 17 is a side view of FIG. 16; and

FIG. 18 shows the manner of mounting an LED signboard to a fixed surface using the mounting structure according to the fourth preferred embodiment of the present invention.

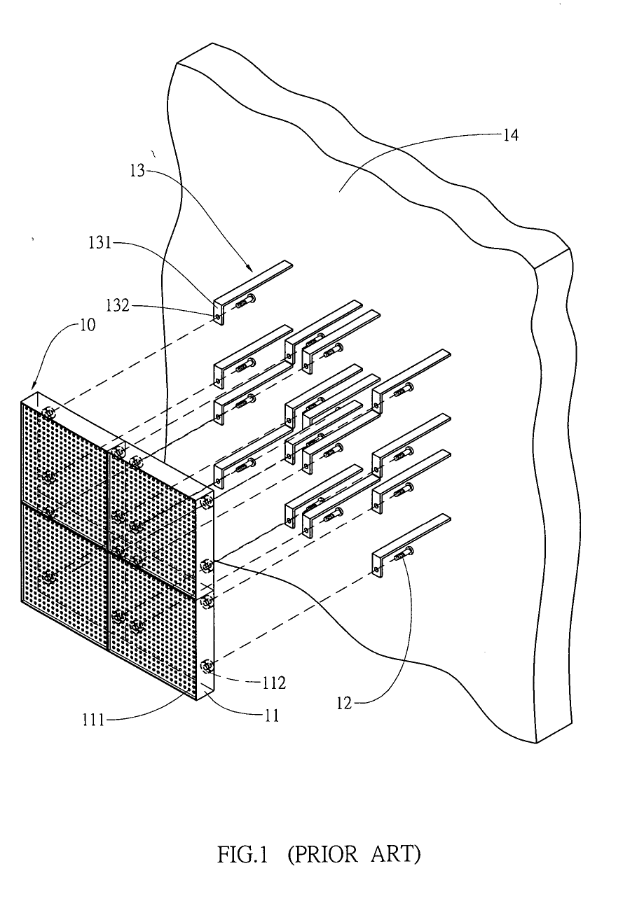

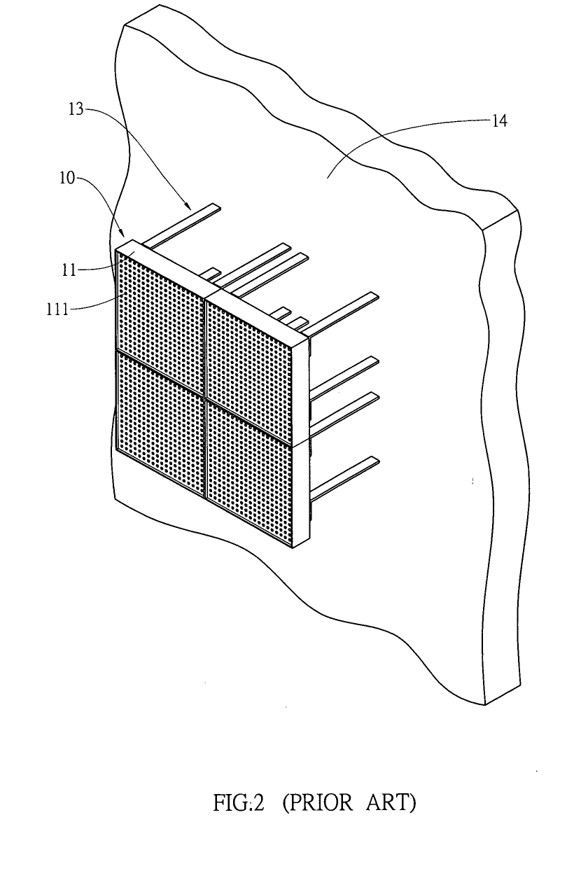

### DETAILED DESCRIPTION OF THE PREFERRED EMBODIMENTS

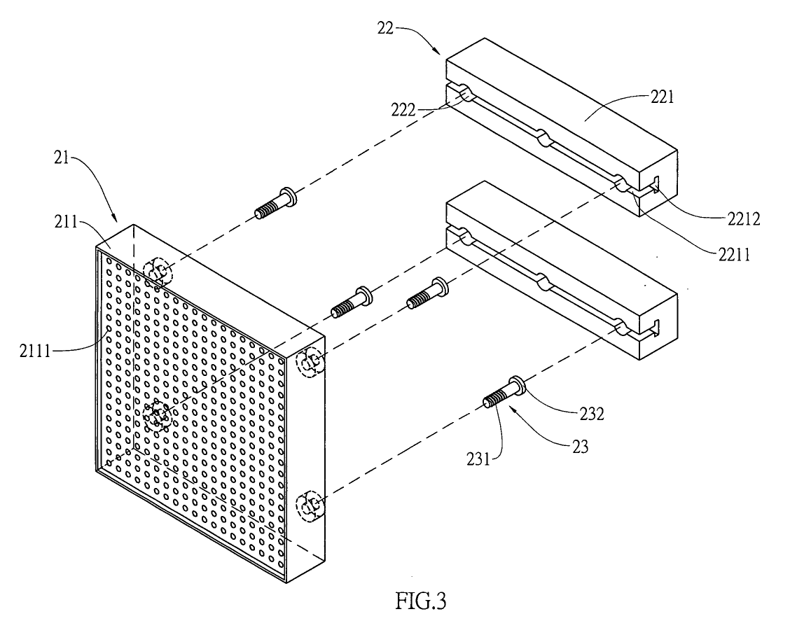

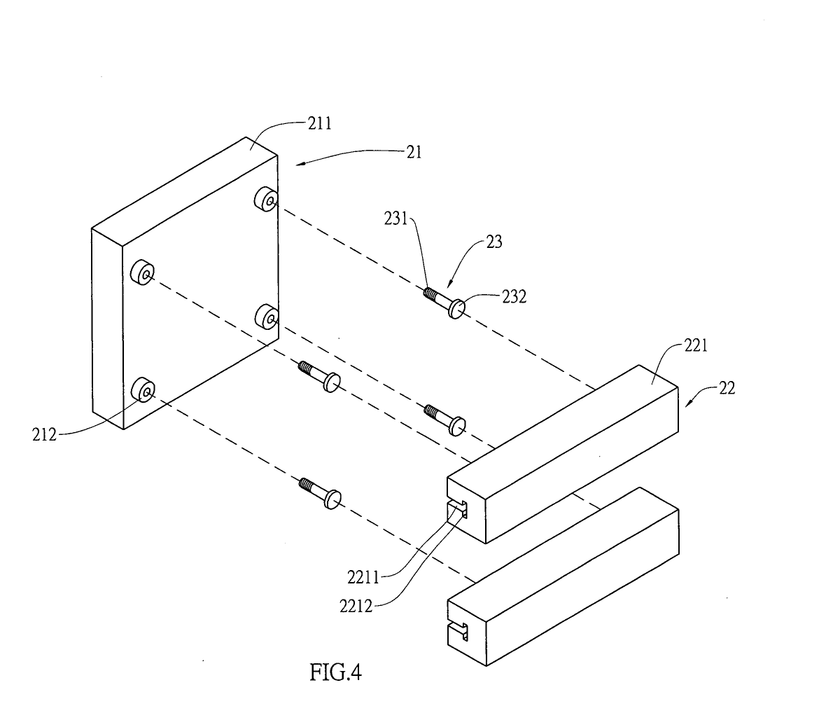

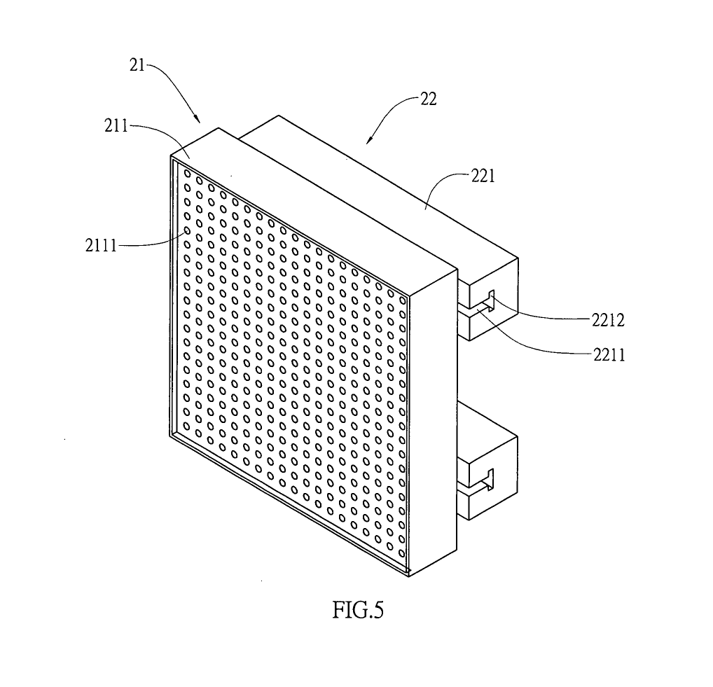

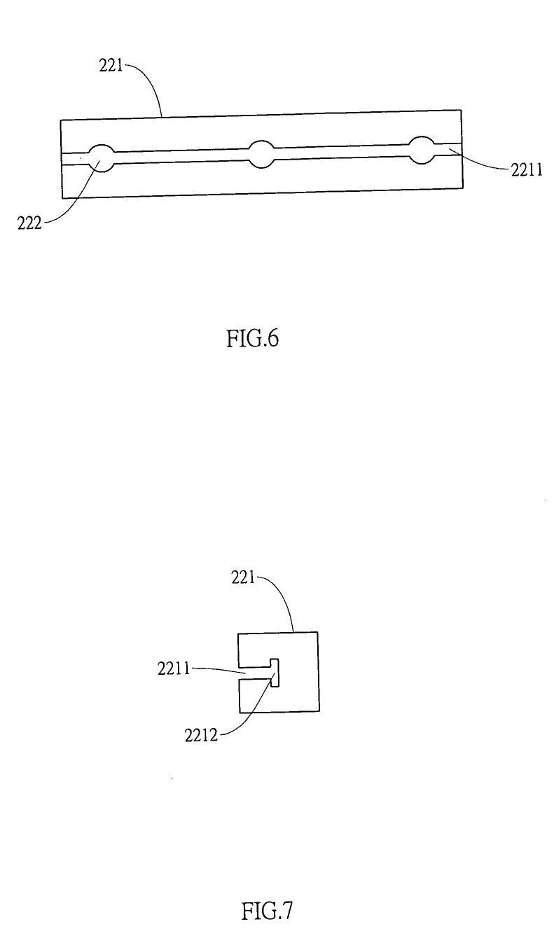

Please refer to FIGS. 3 through 8 in which an LED signboard mounting structure according to a first preferred embodiment of the present invention is shown. As shown, the LED signboard mounting structure is used to mount at least one LED module 21 on a fixed surface, and includes at least one mounting support 22 and a plurality of interconnecting elements 23. The LED module 21 includes a case 211, in which a plurality of LED elements 2111 are provided, such that the LED elements 2111 could be externally viewed from a front side of the case 211. The case 211 is externally provided at every back corner with a receiving area 212, to which the interconnecting element 23 is connected.

In the first preferred embodiment of the present invention, two mounting supports 22 are provided for each LED module 21. Each of the mounting supports 22 includes a main body 221 having a groove 2211 provided at a front side of the main body 221 to transversely extend a full length of the mounting support 22. The groove 2211 has a depth smaller than that of the main body 221. A rear side of the groove 2211 is formed into a retaining channel 2212. As can be clearly seen in FIG. 7, the retaining channel 2212 has an overall height larger than that of the groove 2211 to project upper and lower ends from upper and lower sides of the groove 2211, respectively. That is, when viewing from a lateral end of the main body 221, the retaining channel 2212 is perpendicular to and communicable with the groove 2211. Moreover, at least one expanded hole 222 is provided at the front side of the main body 221 on the groove 2211 to extend from a front open side of the groove 2211 to the retaining channel 2212. In the first preferred embodiment of the present invention, the hole 222 is a round-sectioned hole.

The number of the interconnecting elements 23 is the same as that of the receiving areas on the case 211. Each of the interconnecting elements 23 includes an engaging portion 231, and a hooking portion 232. The hooking portion 232 has a profile similar to that of the expanded hole 222, and has a diameter slightly smaller than that of the expanded hole 222. Moreover, the hooking portion 232 has a cross-sectional area larger that that of the engaging portion 231.

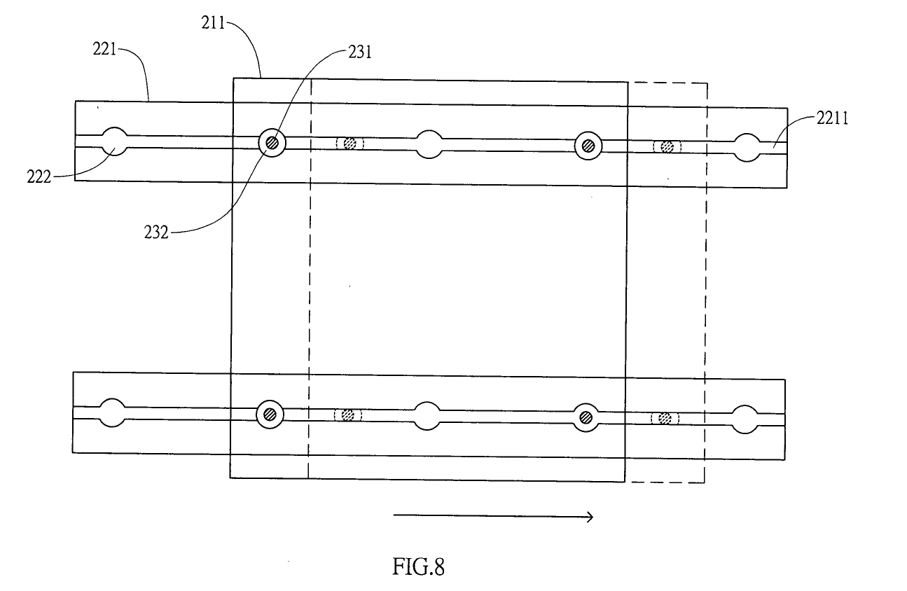

Please refer to FIG. 8. To connect the LED module 21 to the mounting structure of the present invention, first sequentially engage the engaging portions 231 of the interconnecting elements 23 with the receiving areas 212 on the case 211, and then hold the case 211 with a rear side of which facing toward the mounting supports 22, such that the hooking portions 232 of the interconnecting elements 23 already engaged with the receiving areas 212 on the case 211 are aligned with the expanded holes 222 on the two mounting supports 22. Thereafter, push the case 211 toward the mounting supports 22, so that the hooking portions 232 of the interconnecting elements 23 are extended into the groove 2211 via the expanded holes 222 to finally reach at the retaining channels 2212. Finally, sideward move the whole LED module 21, so that the hooking portions 232 are sideward moved along the retaining channels 2212 to positions offset from the expanded holes 222. At this point, the hooking portions 232 of, the interconnecting elements 23 are completely located in the retaining channels 2212, as shown by the phantom line in FIG. 8. That is, the hooking portions 232 are restricted by the retaining channels 2212 to firmly hook to the retaining channels 2212, bringing the LED module 21 to connect to the mounting structure of the present invention.

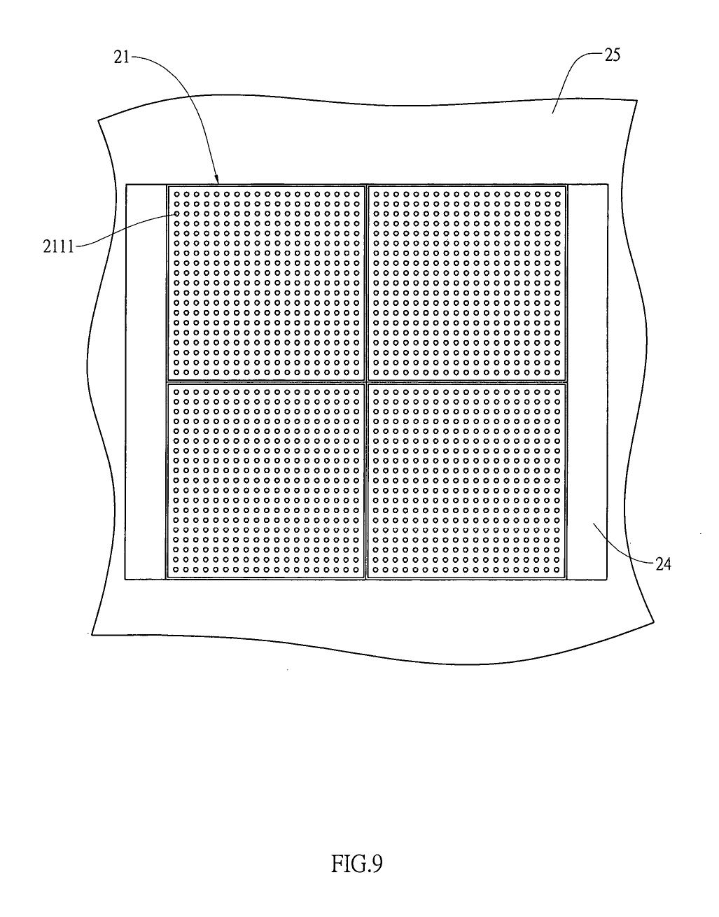

Please refer to FIG. 9 along with FIGS. 3, 4, 5, and 8. A big-sized LED signboard may be assembled from a plurality of LED modules 21 according to actual needs. With control circuits provided in the case 211, different visual effects may be displayed on the big-sized LED signboard.

It is possible to first connect the mounting supports 22 at a back side opposite to the groove 2211 to a fixed surface 25, and then sequentially connect the LED modules 21 to the mounting supports 22 in the above-mentioned procedures to form the big-sized LED signboard. Stoppers 24 may be provided on the mounting supports 22 to locate at two lateral sides of the completed LED signboard, so as to prevent the LED modules 21 from moving out of or separating from the mounting supports 22.

When any one or more of the LED modules 21 are damaged and require repair, the maintenance person may first remove the stoppers 24 from the mounting supports 22, then sideward moves the LED modules 21 until the hooking portions 232 of the interconnecting elements 23 are moved along the retaining channels 2212 to positions communicating with the expanded holes 222, and pulls the cases 211 of the damaged LED modules 21 from a front side thereof to easily remove the cases 211 from the mounting supports 22. The maintenance person needs not to inconveniently and dangerously dismount LED modules 21 by loosening the interconnecting elements 23 from the back of the case 211.

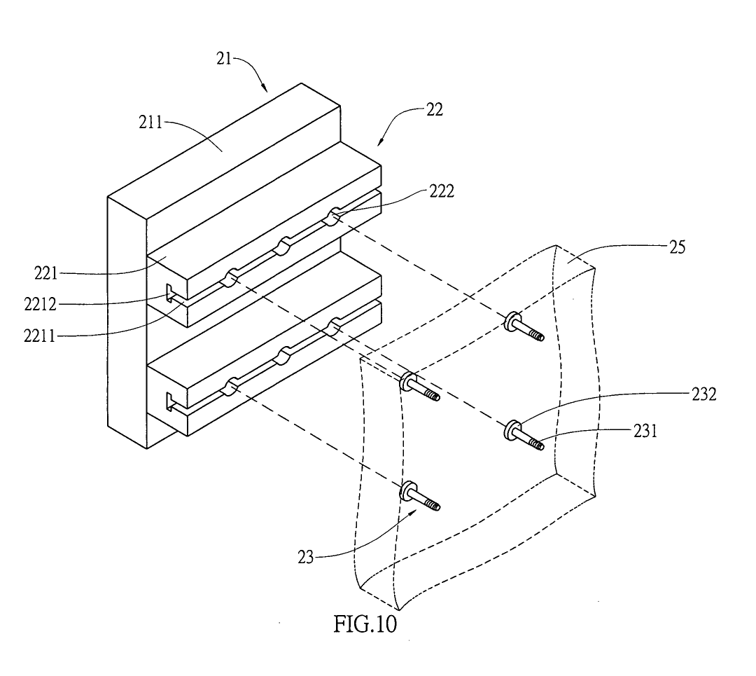

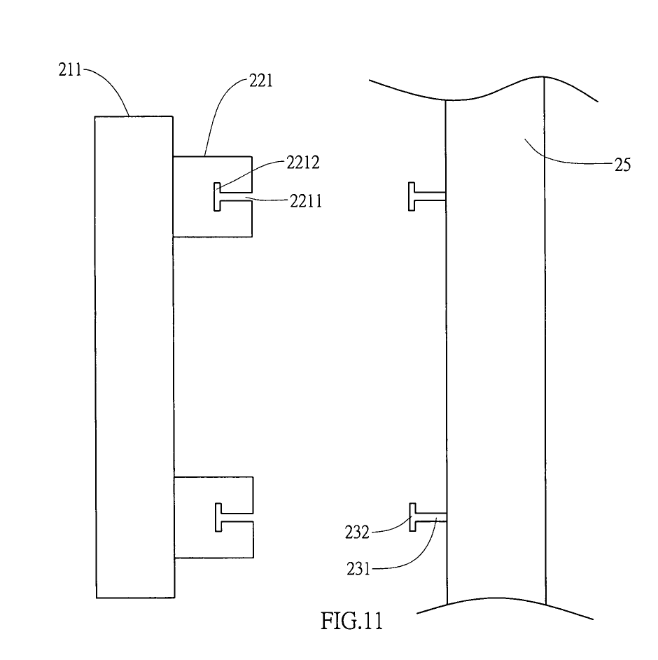

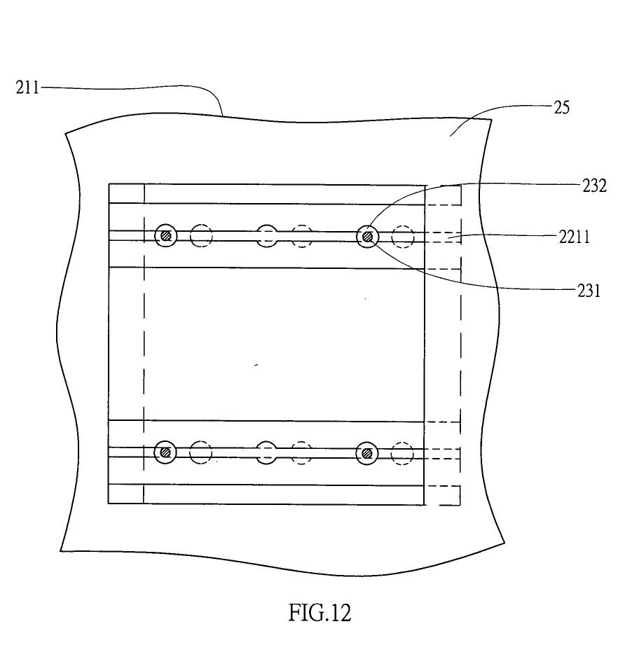

Please refer to FIGS. 10, 11, and 12, in which an LED signboard mounting structure according to a second preferred embodiment of the present invention is shown. The LED signboard mounting structure in the second embodiment is structurally and functionally similar to the first embodiment, except that the main bodies 221 of the mounting supports 22 are connected at the rear sides opposite to the grooves 2211 to the back of the LED module 21, and the engaging portions 231 of the interconnecting elements 23 are fixedly mounted on the fixed surface 25. To mount the LED module 21 on the fixed surface 25, first hold the case 211 with a rear side of which facing toward the interconnecting elements 23, such that the hooking portions 232 of the interconnecting elements 23 projected from the fixed surface 25 are aligned with the expanded holes 222 on the two mounting supports 22. Thereafter, push the case 211 toward the fixed surface 25, so that the hooking portions 232 of the interconnecting elements 23 are extended into the groove 2211 via the expanded holes 222 to finally reach at the retaining channels 2212. Finally, sideward move the whole LED module 21 for the hooking portions 232 of the interconnecting elements 23 to offset from the expanded holes 222 and completely locate in the retaining channels 2212, as shown by the phantom line in FIG. 12.

In another feasible embodiment of the present invention, the main bodies 221 of the mounting supports 22 are integrally formed on the case 211 of the LED module 21.

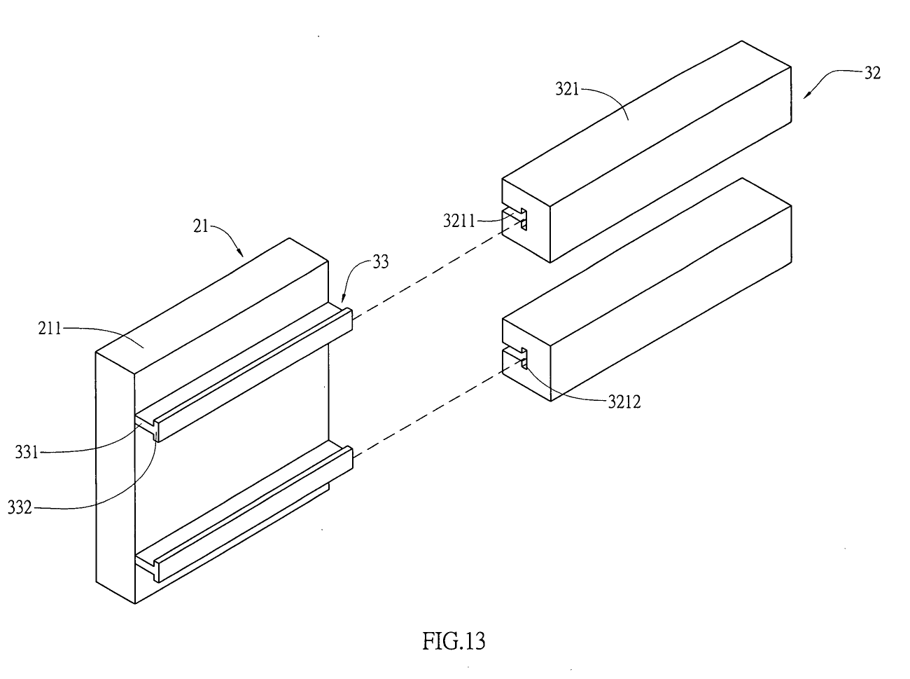

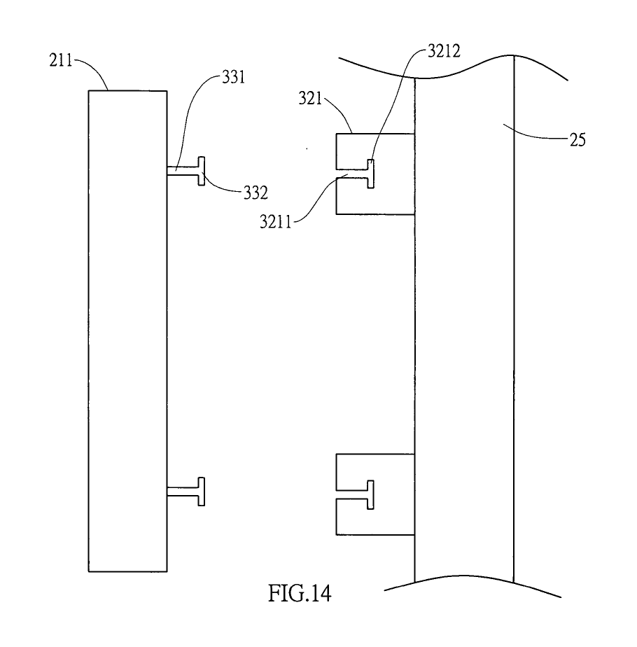

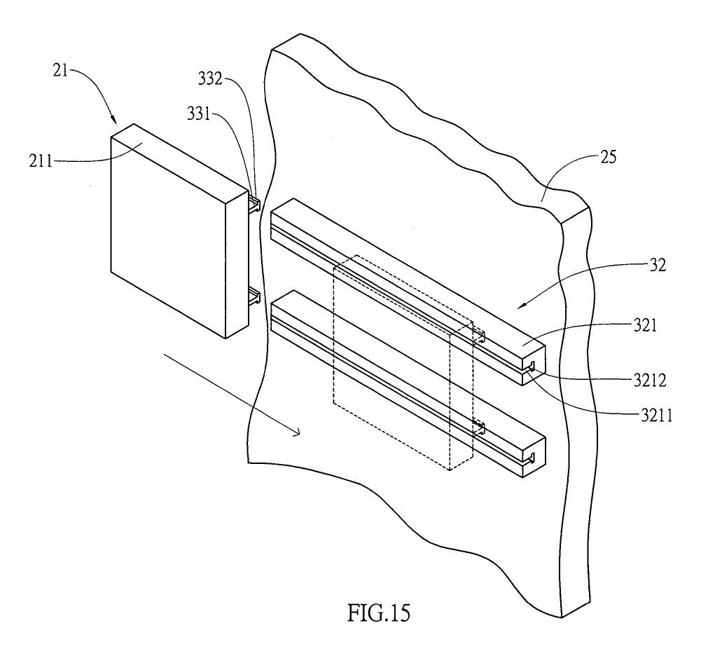

Please refer to FIGS. 13, 14, and 15, in which an LED signboard mounting structure according to a third preferred embodiment of the present invention is shown. The LED signboard mounting structure in the third embodiment is functionally similar to the first embodiment but has mounting supports 32 and interconnecting elements 33 structurally different from the mounting supports 22 and interconnecting elements 23 in the first embodiment. Each of the mounting supports 32 includes a main body 321 having a groove 3211 provided at a front side of the main body 321 to transversely extend a full length of the mounting support 32. The groove 3211 has a depth smaller than that of the main body 321. A rear side of the groove 3211 is formed into a retaining channel 3212. As can be clearly seen in FIG. 14, the retaining channel 3212 has an overall height larger than that of the groove 3211 to project upper and lower ends from upper and lower sides of the groove 3211, respectively. That is, when viewing from a lateral end of the main body 321, the retaining channel 3212 is perpendicular to and communicable with the groove 3211. The main body 321 of the mounting support 32 is connected at a rear side opposite to the groove 3211 to a fixed surface 25. The interconnecting elements 33 are long members located at a rear side and transversely extended a full width of the case 211 of the LED module 21. Each of the interconnecting elements 33 includes an engaging portion 331 and a hooking portion 332. The engaging portion 331 is connected at a front longitudinal edge to the back side of the case 211 and at a rear longitudinal edge to a front side of the hooking portion 332. The hooking portion 332 has a cross-sectional area larger than that of the engaging portion 331.

Please refer to FIG. 15. To mount the case 211 of the LED module 21 to the fixed surface 25 using the mounting structure of the present invention, first hold the LED module 21 with the rear side facing toward the mounting supports 32. Then, move the LED module 21 to a lateral end of the mounting supports 32 with the engaging portions 331 and the hooking portions 332 of the interconnecting elements 33 aligned with the grooves 3211 and the retaining channels 3312 of the mounting supports 32, respectively. Finally, sideward slide the LED module 21 for the interconnecting elements 33 to fully engage with the grooves 3211 and the retaining channels 3212.

In another feasible embodiment of the present invention, the interconnecting elements 33 are integrally formed on the back side of the LED module 21.

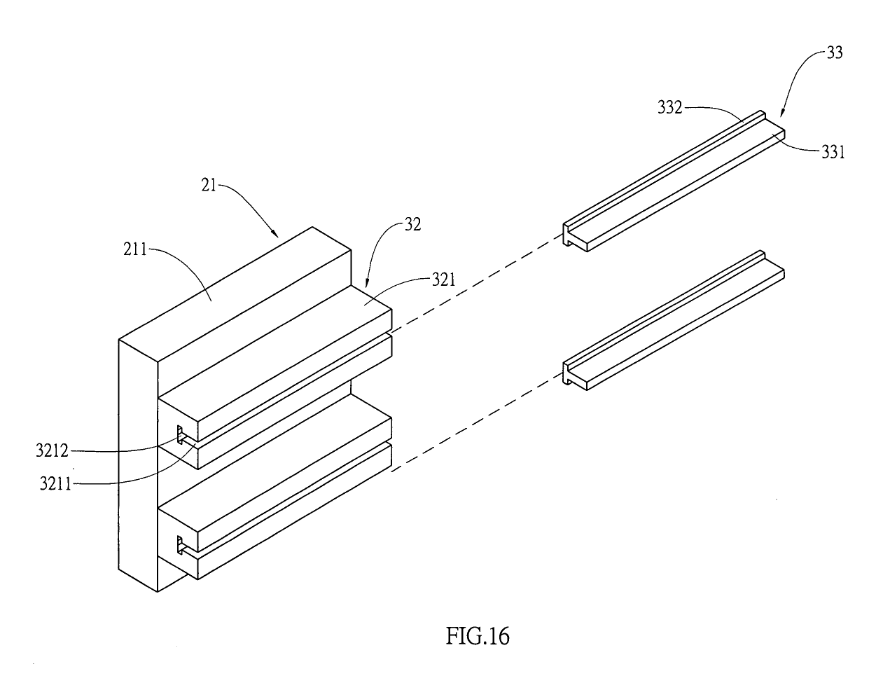

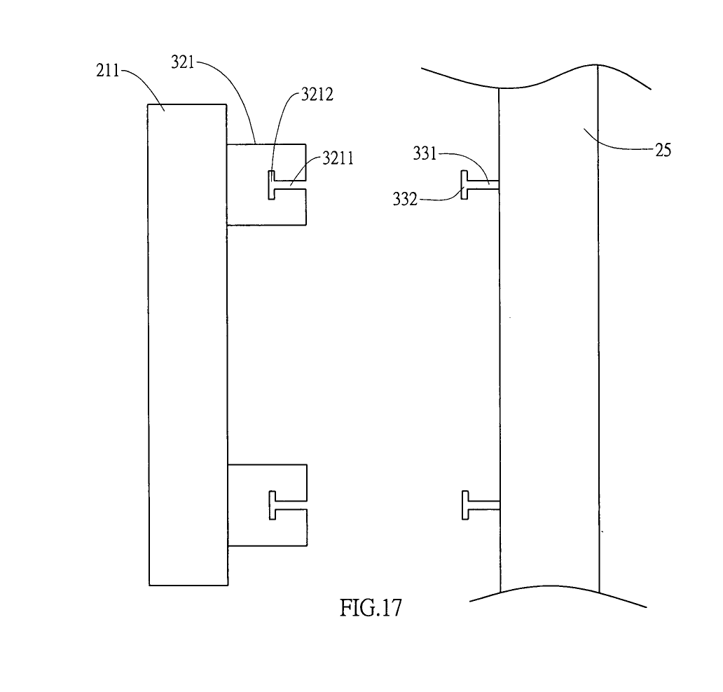

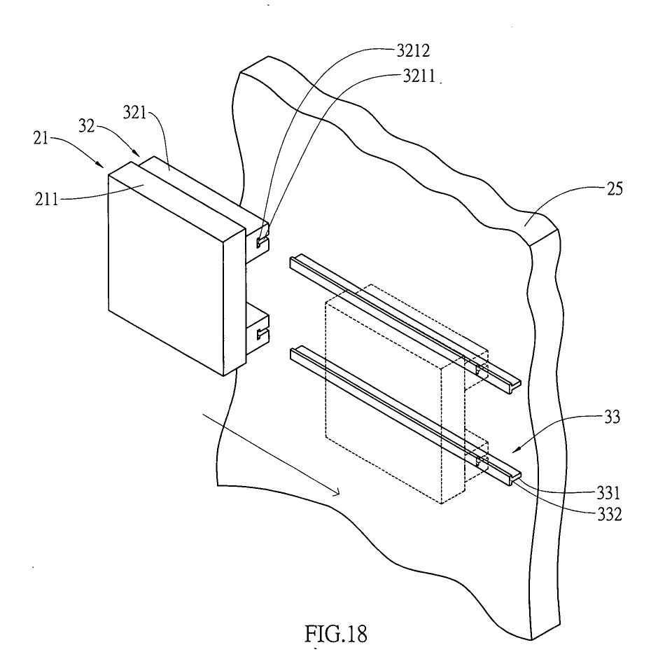

Please refer to FIGS. 16, 17, and 18, in which an LED signboard mounting structure according to a fourth preferred embodiment of the present invention is shown. The fourth embodiment is structurally and functionally similar to the third embodiment, except that the main bodies 321 of the mounting supports 32 are connected at the rear sides opposite to the grooves 3211 to the back of the LED module 21, and the engaging portions 331 of the interconnecting elements 33 are fixedly mounted on the fixed surface 25.

In another feasible embodiment of the present invention, the main bodies 321 of the mounting supports 32 are integrally formed on the back of the LED module 21. The present invention has been described with some preferred embodiments thereof and it is understood that many changes and modifications in the described embodiments can be carried out without departing from the scope and the spirit of the invention that is intended to be limited only by the appended claims.

What is claimed is:

1. An LED signboard mounting structure used to mount at least one LED module on a fixed surface, comprising at least one mounting support, and at least one interconnecting element; said mounting support being formed at a front side with at least one groove transversely extended a full length of said mounting support; said groove having a depth smaller than that of said mounting support, and having a rear side formed into a retaining channel, such that said interconnecting element may correspondingly engage with said groove and said retaining channel on said mounting support.

2. The LED signboard mounting structure as claimed in claim 1, wherein said mounting support is provided at a front side of said groove with at least one expanded hole, said expanded hole being extended through said groove to communicate with said retaining channel, and said interconnecting element being inserted into said groove via said expanded hole.

3. The LED signboard mounting structure as claimed in claim 1, wherein said mounting support is fixedly connected at a rear side opposite to said groove to one of said fixed surface and said LED module, and said interconnecting element is fixedly connected to a remaining one of said fixed surface and said LED module.

4. The LED signboard mounting structure as claimed in claim 2, wherein said interconnecting element includes an engaging portion and a hooking portion connected to said engaging portion, and said hooking portion being adapted to locate in and hook to said retaining channel on said mounting support.

5. The LED signboard mounting structure as claimed in claim 4, wherein said hooking portion of said interconnecting element has a cross-sectional area larger than that of said engaging portion.

6. The LED signboard mounting structure as claimed in claim 1, wherein said interconnecting element is a transversely extended long member, and includes an engaging portion and a hooking portion connected to said engaging portion, and said hooking portion being adapted to locate in and hook to said retaining channel on said mounting support.

7. The LED signboard mounting structure as claimed in claim 6, wherein said hooking portion of said interconnecting element has a cross-sectional area larger than that of said engaging portion.

8. The LED signboard mounting structure as claimed in claim 3, wherein said mounting support is connected to said LED module in a manner selected from the group consisting of being integrally formed on said LED module and being separately formed and then attached to said LED module.

9. The LED signboard mounting structure as claimed in claim 3, wherein said interconnecting element is connected to said LED module in a manner selected from the group consisting of being integrally formed with said LED module and being separately formed and then attached to said LED module.

10. The LED signboard mounting structure as claimed in claim 1, wherein said LED module further includes a case, and said case being internally provided with a plurality of LED elements.

11. The LED signboard mounting structure as claimed in claim 10, wherein said case is externally provided with at least one receiving area, to where said interconnecting element is connected.

12. The LED signboard mounting structure as claimed in claim 1, further comprising at least one stopper for preventing said LED module from moving out of said mounting structure.

13. The LED signboard mounting structure as claimed in claim 1, wherein said retaining channel on said mounting support has upper and lower ends projected from upper and lower sides of said groove and is communicable with said groove.

14. The LED signboard mounting structure as claimed in claim 1, wherein a plurality of said LED modules are connectable to one another to form a big-sized LED signboard according to actual needs.
